(19) United States
(12) Patent Application Publication
(10) Pub. No.: US 2009/0054264 A1
(43) Pub. Date: Feb. 26, 2009

(54) Method of Fabricating an Array of Capillaries on a Chip

(75) Inventors: Nicolas Ugolin, Paris (FR); Pascal Wodling, Fontenay Aux Roses (FR); Julien Le Meur, Pont-Aven (FR); Pierre-Yves Tro, Gif-sur-Yvette (FR); Sylvie Chevillard, Le Kremlin-Bicetre (FR)

Correspondence Address: BIRCH STEWART KOLASCH & BIRCH, PO BOX 747, FALLS CHURCH, VA, 22040-0747, US

(73) Assignee: COMMISSARIAT A L'ENERGIE ATOMIQUE, PARIS (FR)

(21) Appl. No.: 12/224,423

(22) PCT Filed: Feb. 26, 2007
(86) PCT No.: PCT/FR2007/000341

§ 371 Date: Oct. 8, 2008

(30) Foreign Application Priority Data
Feb. 27, 2006 (FR) 06/01704

(51) Int. Cl. C40B 40/00; C40B 50/18; C40B 60/12

(52) U.S. Cl. 506/13; 506/32; 506/39

(57) ABSTRACT

The invention relates to a method of fabricating an array of capillaries of a chip, the method comprising the steps consisting in depositing at least one layer of a meltable or polymerizable construction material on a support plate, focusing and moving a laser beam on and over said layer respectively to melt or polymerize the material so as to form the side walls of the capillaries, and then fastening a cover plate on the side walls of the capillaries. The invention also provides a chip including an array of capillaries in which chemical or biological molecules are fixed, and a chip including an array of chromatography and/or electrophoresis capillaries.

The present invention relates to a method of fabricating an array of capillaries on a chip or a biochip. The invention also relates to a chip including an array of capillaries having chemical or biological molecules fixed therein and organized as a matrix of probes, and it also relates to a chip including an array of electrophoresis and/or chromatography capillaries.

In the present application, the terms “chip” and “biochip” have the same meaning and designate a component that includes an array of capillaries and that can be used in numerous fields such as microfluidics, capillary electrophoresis, chromatography, electrochromatography, etc., and analysis for a variety of applications such as biological, medical, pharmaceutical, food industry, environmental, etc. purposes.

In the context of analyzing a mixture of polynucleotide molecular targets, a chip or a biochip comprises an array of capillaries and a matrix of molecular probes organized as spots and fixed in the capillaries, the molecular probes being of different types and each possessing a nucleotide sequence capable of bonding by molecular hybridation specifically with a single type of molecular target in the mixture when the mixture is brought into contact with the molecular probes.

The molecular target of the mixture flowing in the capillaries of the chip, e.g. merely by the mixture diffusing, come into contact with the molecular probes and bond specifically thereto to form probe-target complexes that are detected and/or quantified, e.g. by measuring the fluorescence emitted by fluorescent markers previously attached to the molecular targets.

Alternatively, the molecular targets may be caused to flow in the capillaries by applying an electric field to the capillaries by means of electrodes grafted or deposited on as a thin layer on the chip. When each molecular probe is associated with a pair of electrodes, probe-target complexes can be detected and/or quantified by measuring impedance between each pair of electrodes.

It is known to form an array of capillaries of a chip in a plate of plastics material by laser machining, which technique consists in focusing and moving a laser beam on and over a surface of the plate in order to dig out the capillaries by ablating the plastics material of the plate. Nevertheless, that technique is complex and very expensive to implement, and it must be performed before grafting or depositing electrodes and before fixing molecular probes on the plate in order to avoid damaging or destroying them. Furthermore, laser machining of the plate can give rise to defects being formed such as beads along the outside longitudinal edges of the capillaries.

An array of capillaries of a chip can also be formed in a plate of a suitable material, such as silica, by depositing a chemically corrosive agent such as an acid or a base on a surface of the plate in order to dig out the plate by chemical etching, thereby forming the capillaries. Nevertheless, such chemical agents are incompatible with biological material and they must therefore be applied to a plate that is free from molecular probes in order to avoid any risk of destroying the probes. One solution to the problem would consist in covering the molecular probes fixed on the plate with a protective mask. Nevertheless, that technique is not very effective and it is very expensive to implement. In addition, forming an array of capillaries by chemical etching does not make it possible to have capillaries of dimensions that are accurate and uniform, and therefore limits the applications of capillary arrays obtained by that technique.

In general, known fabrication methods do not make it possible, or make it possible only with great difficulty, to fabricate complex arrays of capillaries capable of receiving a large number of different chemical or biological molecules, e.g. several thousands of molecules.

A particular object of the present invention is to provide a solution to these problems that is simple, effective, and inexpensive.

To this end, the invention provides a method of fabricating an array of capillaries of a chip, the method being characterized in that it comprises the steps consisting in:

a) depositing at least one layer of a meltable construction material or of a polymerizable construction material on a support plate that is to form the bottoms of the capillaries;

b) focusing and moving a laser beam on and over predetermined zones of the or each layer of the construction material in order respectively to melt or to polymerize the material in said zones so as to form the side walls of the capillaries; and

c) fixing a cover plate on the side walls of the capillaries, after they have hardened, the cover plate forming the ceilings of the capillaries.

The method may further consist, before step a) and/or c), in fixing chemical or biological molecules on the support plate and/or on the cover plate, on the bottom and/or the ceiling of at least one of the capillaries, and optionally in covering said molecules in a layer of a soluble protective material.

The method of the invention is simpler to implement than the techniques presently in use and it enables an array of capillaries of a chip or a biochip to be fabricated in which the capillaries do not present defects and are of dimensions that are accurate and uniform. The method of the invention makes it possible to fabricate complex arrays of capillaries capable of receiving a large number of chemical or biological molecules fixed in the capillaries (e.g. several thousands of different molecular probes), with the complexity of the array of capillaries depending on the desired application.

The array of capillaries obtained by the method of the invention is formed between a bottom plate referred to as a “support” forming the bottoms of the capillaries and a top plate referred to as a “cover” and forming the ceilings of the capillaries. The side walls of the capillaries are formed by one or more layers of a construction material that is melted or polymerized on the support plate by means of a laser beam.

In the present application, the term “wall” or “side wall” designates a partition separating the medium contained in each capillary from the medium in the other capillaries, and where appropriate in other elements of the chip. In particular, said wall may, for example, separate two adjacent capillaries, or separate a capillary from an edge of the chip. The side walls that define a capillary may also coincide with or be separate from the side walls of adjacent capillaries.

The construction material used in the method of the invention should be understood as covering any type of material that can be melted, or alternatively any type of material that can be polymerized, by means of a laser beam.

With a meltable construction material, the laser beam is used to heat the material so as to deliver the energy needed for melting it. The energy needed for melting the construction material depends on the melting temperature of the material. The meltable construction material is preferably selected from materials having a melting temperature that is relatively low (e.g. lying in the range about 150° C. to about 300° C.) in order to limit laser energy consumption and in order to avoid damage by thermal conduction to the support plate and/or to any molecules fixed on said support plate. When the support plate can withstand very high temperatures and does not carry any biological materials, then the construction material may have a melting temperature of up to 1000° C., or even more.

In a variant, the meltable construction material is preheated to a temperature that is below its melting temperature, and the laser beam is used to deliver only the extra energy needed to melt it.

In the present application, the term “meltable” thus designates a compound that can be melted by being exposed to a laser beam.

Melting the construction material with the help of a laser beam presents numerous advantages compared with melting said material by depositing it in a heated enclosure such as an oven. Using a laser beam makes it possible in particular to cause the construction material to melt more quickly and more accurately because of the concentration of a large quantity of energy in a beam of small section.

With a construction material that is polymerizable, the laser beam is used to trigger or initiate polymerization of the material. The construction material then comprises monomers of at least one type together with photochemical triggers that will decompose and serve to trigger polymerization of the material on being exposed to a laser beam at a determined wavelength. By way of example, on being exposed to a laser beam, photochemical triggers can decompose into free radicals and can give rise to radical polymerization of the construction material.

In the present application, the term “polymerizable” thus relates to a method in which polymerization can be triggered or initiated by being exposed to a laser beam.

The polymerization of the construction material by triggering by means of a laser beam presents numerous advantages compared with polymerization by triggering using some other source of light, such as any kind of lamp, for example. Having recourse to a laser beam makes it possible to increase the depth of polymerization in the layer of material, to increase the degree of polymerization, and to reduce the time required by the material for polymerization. Furthermore, it does not require an opaque mask to be used that is designed to be placed on the layer of material and allow light radiation to pass from the lamp to those locations where polymerization is to take place. Furthermore, that type of mask (which is lengthy and expensive to make) can be placed only on a construction material that is in the form of a film, and it cannot be used on a construction material that is in the form of a gel or a powder.

In general, the method of the invention consists in forming the side walls of the capillaries of the network by means of a construction material and the energy delivered by a laser beam, said energy being used either to cause the construction material to melt if it is a meltable material, or to initiate polymerization of the construction material if it is a polymerizable material.

Step a) of the method of the invention consists in depositing at least one layer of construction material on the support plate.

The term “layer” of material is used to mean a quantity of material that is sufficient to cover all or part of the surface of the support plate forming the bottoms of the capillaries. This surface of the support plate can thus be completely covered in a layer of construction material or in two or more optionally independent, coplanar layers of this material.

In a first implementation, the support plate is entirely covered in a layer of construction material in which the side walls of the capillaries are to be formed.

In a second implementation, the support plate is covered in two independent coplanar layers of the construction material, the side walls of at least one capillary being formed in each of the layers of material.

In a third implementation, the support plate is covered in two layers of material that meet, and in particular that are juxtaposed, in at least one region of the support, the side walls of at least one capillary being formed in each of the layers of material and being connected, in the above-mentioned regions, to the side walls of at least one capillary formed in the other layer of material, so as to form a fluid flow connection between the capillaries.

Step b) of the method of the invention consists in focusing and moving a laser beam on and over predetermined zones of the or each layer of construction material so as to form the side walls of the capillaries by polymerizing or by melting the material in said zones.

Each of these zones may correspond to all or part of a layer of construction material.

By way of example, when a layer of construction material covers an entire surface of the support plate, the laser beam may be focused on and moved over only those zones of said layer that are adjacent to the locations of future capillaries, or zones of the layer that are situated between the locations of the future capillaries, and between said locations and the edges of the support plate.

When two or more layers are deposited on a surface of the support plate, the laser beam can also be focused on and moved over zones of said layers solely beside the locations of the future capillaries or occupying zones of greater extent. If the layers of material are deposited on the support plate away from the locations of the future capillaries, the laser beam can be focused on and moved over these layers of material in full.

The laser beam may be moved, for example, by means of galvanometric or piezoelectric control mirrors. By way of example, the laser beam is of the pulsed type and the size of the point of impact of the laser beam typically presents a diameter of less than 50 micrometers (μm), for example lying in the range about 20 μm to 30 μm.

Step c) of the method of the invention consists in fastening the cover plate on the side walls of the capillaries, after they have hardened.

The hardening of the side walls of the capillaries must be understood as being the end of the polymerization of the polymerized construction material or of the cooling down to ambient temperature, for example, of the melted construction material.

The cover plate and the support plate may be both of the same type or they may be of different types.

The method of the invention may further comprise, prior to step c), the step consisting in repeating steps a) and b) one or more times until the side walls of the capillaries reach a predetermined height.

The or each layer of construction material deposited in step a) has thickness lying in the range about 1 μm to 2000 μm, and the capillaries typically have height lying in the range about 1 μm to about 2000 μm. Forming the walls of the capillaries can thus require one or more layers of construction material to be deposited (one or more steps a)), each lower layer of material being exposed to the laser beam prior to a higher level of material being deposited thereon, (i.e. each step a) is directly followed by a step b)).

The method of the invention may also comprise a step consisting in removing the non-melted or non-polymerized construction material, this step being performed before step c) or after each step b), i.e. immediately prior to fastening the cover plate on the walls of the capillaries, or after a layer of construction material has been deposited on the support plate and the zones of said layer have been exposed to the laser beam, and before and additional layer is superposed on said layer.

The non-melted or non-polymerized construction material can be removed by dipping the support plate in a bath suitable for dissolving the material, by laser ablation, by mechanical removal, by sweeping with a liquid or a gas under pressure that is sprayed onto the support plate, etc.

The method of the invention may also include a step consisting in fixing chemical or biological molecules on the support plate, which molecules may be fixed in the capillaries, prior to step c), or in register with the bottoms of the future capillaries, prior to step a).

The fixing of the chemical or biological molecules, e.g. by coupling, on the support plate is performed with the help of any suitable method, and by way of example by polymerization, electropolymerization, or in situ synthesis, by mechanical deposition using a robotic system, e.g. equipped with needles and/or pipettes of the piezoelectric type, etc.

In general, all types of coupling, such as chemical bonds or strong interactions used in chromatography columns might possibly be suitable. Nevertheless, the fixing of molecules on the support plate needs to be sufficiently strong to withstand the various treatments that are applied and to withstand any electric fields that might be used for moving other molecules along the capillaries, such as molecular targets.

By way of example, the chemical or biological molecules are selected from amongst nucleic acids, and in particular deoxyribonucleic acid (DNA), ribonucleic acid (RNA), or peptide nucleic acid (PNA), or optionally-marked mixtures of DNA and PNA or of RNA and PNA, polypeptide compounds, chemical or biological ligands, antibodies, or antibody fragments, etc.

The method of the invention may further comprise, after fixing chemical or biological molecules on the support plate, and prior to step c), a step consisting in fixing chemical or biological molecules on the cover plate, in register with the ceilings of the future capillaries.

The molecules fixed on the support plate are independent of the molecules fixed on the cover plate, but they can sometimes interact therewith.

In a variant, molecules may be fixed to the support plate via one of their ends with their other ends being fixed on the cover plate, or at least interacting therewith, after it has been fastened on the side walls of the capillaries.

In another variant, the chemical or biological molecules are fixed solely on the cover plate.

The molecules are preferably organized as spots and they are regularly distributed relative to one another so as to form a matrix of spots. The matrix comprises p rows of n spots or n columns of p spots, each row of spots being situated in a capillary of the array, and the number of rows of spots corresponding to the number of capillaries (or each column of spots is situated in a capillary of the array and the number of columns of spots corresponds to the number of capillaries).

The method of the invention may also comprise, before step c), a step consisting in filling at least one of the capillaries with a porous monolithic substance forming a stationary phase so as to constitute a chromatography capillary.

Any type of porous monolithic substance suitable for chromatography can be used, the or each chromatography capillary possibly being filled with the substance by in situ polymerization or by some other suitable technique.

In step c), the method of the invention may consist in releasably fastening the cover plate on the side walls of the capillaries, e.g. by means of an adhesive or contacting film (such as polydimethyl siloxane (PDMS)), in order to enable the array of capillaries to be opened and closed at will.

In a particular implementation of the invention, the method consists, in step a), in depositing at least one layer of a polymerizable construction material in the form of a gel or a film on the support plate, and in step b), in focusing and moving a laser beam on and over predetermined zones of the or each layer of construction material in order to cause the material to polymerize in said zones so as to form the side walls of the capillaries.

Prior to step a) and/or c), the method may also consist in fixing chemical or biological molecules on the support plate and/or on the cover plate in register with the bottoms and/or the ceilings of at least one of the capillaries, and optionally in covering these molecules in a layer of soluble protective material.

The or each layer of construction material in the form of a gel or a film is deposited on the support plate by any suitable technique, and for example by a robotic system.

Polymerizing this type of material makes it possible to obtain capillary walls that are impermeable, sealed, and smooth.

Photo-imageable films such as those sold by the supplier DuPont under the name Vacrel® or Riston® are particularly suitable for fabricating an array of capillaries by the method of the invention. The polymerization of this type of film is triggered by exposure to visible radiation. The method of the invention then consists, in step b), in using a laser that emits a beam of visible light (wavelength of about 532 nanometers (nm)).

After the end of polymerizing the construction material and hardening the side walls of the capillaries, the non-polymerized construction material can be removed from the support plate. When the support plate is covered entirely in a layer of construction material, it is necessary to remove non-polymerized construction material from the support plate in order to cause the capillaries appear.

Steps a) and b) can be repeated one or more times when necessary prior to fastening the cover plate on the side walls of the capillaries, as performed in step c).

The method of the invention may also include a step consisting in removing the non-melted or non-polymerized construction material, this step being performed prior to step c), or after each step b).

Prior to step c), the method of the invention may also include a step that consists in filling at least one of the capillaries with a porous monolithic substance forming a stationary phase in order to form a chromatography capillary.

In step c), the method of the invention may consist in releasably fastening the cover plate on the side walls of the capillaries, e.g. by means of an adhesive or contacting film, in order to enable the array of capillaries to be opened and closed at will.

In step c), the method of the invention may consist in:

c₁) covering the side walls of the capillaries in a film of material having a low melting temperature, after the walls have hardened;

c₅) placing the cover plate on the film of material; and

c₆) focusing and moving a laser beam in register with the side walls of the capillaries to melt the film on the side walls so as to fasten the cover plate adhesively on the side walls of the capillaries.

The film of material, e.g. a film of paraffin or of an EVA copolymer having a thickness of about 1 μm to 2 μm is melted locally by being exposed to a laser beam and it enables the cover plate to be fastened adhesively on the side walls of the capillaries. Adhesively bonding the cover plate by means of a film of meltable material is advantageous compared with using an adhesive in liquid or gel form since such an adhesive tends to penetrate into the capillaries and to block them.

Advantageously, this method consists in releasably fastening the cover plate on the side walls of the capillaries to enable the array of capillaries to be opened and closed at will. The cover plate may be detached from the array of capillaries either manually or by means of a suitable tool, and it may be fastened back onto the side walls of the capillaries by melting another film of meltable material that has been deposited on the walls of the capillaries, or by using the previously used film of material, providing it is capable of being melted several times without degrading.

The laser used to deliver the energy needed for melting the film of material may be of the same type as or of a type that is different from the laser used for polymerizing the construction material (which may itself be in the form of a film).

The film of material has a low melting temperature, i.e. a melting temperature that is low enough to avoid degrading the side walls of the capillaries by thermal conduction. The melting temperature of a film of EVA copolymer is about 176° C.

The laser beam is focused on and moved in register with the walls of the capillaries and passes through the cover plate that is selected to be transparent at the wavelength of this laser beam.

The film of material may be melted continuously or at points along the walls of the capillaries, with the laser used for melting the film of material being a laser of the pulsed type, for example.

When the film of material also covers the capillaries and closes them, the method of the invention may further comprise, after above-mentioned step c₁), the step consisting in:

c₂) focusing and moving a laser beam along the capillaries to open the capillaries by eliminating the film of material from the ceilings of the capillaries.

This step may be for example be necessary in order to avoid any interaction between the film of material and the chemical or biological molecules fixed in the capillaries on the support plate, and/or other molecules flowing in the capillaries. This step may also be necessary to avoid the film of material covering electrodes of the cover plate and disturbing the application of an electric field in the array of capillaries.

The capillaries that have been covered and closed by the film of meltable material must also be opened again in order to fix chemical or biological molecules in the capillaries, as described above.

The laser used for eliminating the film of material may be of the same type as that used for causing the film to melt, the laser beam then being focused on the middle of each capillary and being moved along the capillary so as to cause the film of material to melt and the melted film to retract onto the outer longitudinal edges of the capillaries.

Alternatively, the film of material may be eliminated by laser ablation, i.e. by subliming the film of material by means of a suitable laser.

The method of the invention may also comprise, after step c₁) or step c₂), and before step c₅), the steps consisting in:

c₃) fixing chemical or biological molecules on the support plate in the capillaries; and

c₄) covering these molecules in a layer of soluble protective material.

The protective material is for covering the molecules in the capillaries and for protecting them against physiological, chemical, or thermal attack, in particular against the radiation and the heat caused by focusing the laser beam onto the side walls of the capillaries for the purpose of adhesively fastening the cover plate on the walls of the capillaries. The capillaries may be filled completely or in part with the protective material.

In the present application, the term “soluble” is used to mean a compound that can be dissolved in a solvent, the solvent being compatible with using the biological or chemical material of the molecules contained in the capillaries.

Once the cover plate has been fastened on the walls of the capillaries, the protective material may be used as a diffusion medium for molecules in the capillaries, and/or it may be removed from the capillaries by being dissolved in a suitable solvent injected into the capillaries by channels or pores formed in the support plate and/or the cover plate, and evacuated from the array of capillaries through the same channels or pores.

The channels or pores formed in the support plate and/or the cover plate may open out directly into the capillaries or into reservoirs that are connected to the capillaries.

By way of example, a gel of polyacrylamide or of agarose maybe used as the protective material and it may be conserved in the capillaries after they have been closed since this type of gel is particularly suitable for regulating and controlling the diffusion of molecules in capillaries when they migrate merely by diffusion or by application of an electric field when performing electrophoresis.

In a variant, or as an additional characteristic, the chemical or biological molecules fixed on each support plate are protected by means of a photolithographic mask placed on the cover plate between above-mentioned steps c₅) and c₆), the mask being in the form of an array of capillaries and serving to form a screen that is opaque to the laser beam used for melting the film of material through the cover plate. The mask may be made directly on the cover plate by using a laser beam to melt a suitable powder, such as black toner powder for a printer, as described above. The non-melted powder can subsequently be removed from the cover plate with the help of a jet of compressed air.

In another particular implementation of the invention, the method of the invention consists, in step a), in depositing at least one layer of meltable construction material in the form of a powder on the support plate, and in step b), in focusing and moving a laser beam onto and over predetermined zones of the or each layer of construction material in order to melt the material in these zones as to form the side walls of the capillaries.

The or each layer of construction material in powder form is deposited on the support plate by any suitable technology, e.g. using a robotic system.

In a variant, the construction material is electrostatically charged and the support plate has electrodes at the locations of the side walls of the future capillaries that are to form an electrostatic field of charge opposite to that of the powder in order to hold the powder on the support plate. Step a) then consists in depositing a layer of powder on a surface of the support plate so as to cover the surface in full, and then remove the powder that is not held on the support plate by electrostatic interaction, e.g. merely by sweeping with a jet of compressed air.

When the powder of the construction material is electrostatically charged, it can also be deposited on the support plate at locations for the side walls of the capillaries by means of a photoconductor element that is plane or drum-shaped. The surface for treatment on said element is scanned by a laser beam so as to form electrostatic charges at the locations of the side walls of the future capillaries. A layer of powder having charge opposite to that of the treated surface of the element is deposited on said surface and is held thereon at those locations where the electrostatic charges have been formed. This layer of powder is then pressed against the support plate and transferred thereto by forming an electrostatic field on the support plate, as described above.

The meltable construction material may be organic, or metallic, or may it be a plastics material or a ceramic. The size of the grains of the construction material powder should be relatively uniform and preferably lies in the range about 0.1 μm to about 20 μm, and for example in the range about 0.5 μm to about 10 μm. Melting such a powder makes it possible to obtain capillary walls that are impermeable, sealed, and relatively smooth.

The wavelength of the laser is selected to match the absorption band of the construction material, and for example it may be situated in the infrared range (IR: 0.75 μm to 300 μm), the visible range (400 nm to 800 nm), or the ultraviolet range (UV: 190 nm to 400 nm).

By way of example, it is possible to use as a meltable organic material: sugar in powder form (the laser being used to cause melting and/or carbonization of the sugar); as a meltable plastics material: a powder of polymethylmethacrylate, polyvinylchloride, polyethylene, a polyurethane, an EVA copolymer, an acrylonitrile butadiene styrene (ABS) copolymer, etc.; and as a meltable ceramic material: an alumina powder.

The method of the invention also makes it possible to make the side walls of the capillaries of the array out of metal. Forming the side walls of the capillaries by melting a metal foil by means of a laser requires a large amount of energy and leads to high temperatures that might act by thermal conduction to degrade the support plate on which the metal foil is deposited, and also to degrade any electrodes grafted or deposited on said plate. In contrast, using a laser to melt a metal powder, such as powdered titanium alloy, does not require the laser to deliver too much energy and presents a smaller risk of the support plate or its electrodes being damaged.

When the walls of the capillaries are formed by melting a metal powder on a support plate that includes electrodes, the method may include an additional step consisting in covering the support plate (and possibly also the cover plate if it also has electrodes) in a film of an electrically insulating material so as to isolate the electrodes electrically from the walls of the capillaries. By way of example, the film may be based on an EVA copolymer and/or on a polyimide such as Kapton® that can be removed from the bottoms and the ceilings of the capillaries as described above to suppress the film of material. It is also necessary for the film to be capable of withstanding, without being degraded, the melting temperature of the construction material powder that is to be deposited thereon in step a).

Steps a) and b) may be repeated one or more times, where necessary, prior to fastening the cover plate on the side walls of the capillaries, as is performed in step c).

The method of the invention may also comprise a step consisting in withdrawing the non-melted or non-polymerized construction material, this step being performed before step c) or after each step b).

The method of the invention may further comprise, prior to step c), a step consisting in filling at least one of the capillaries with a porous monolithic substance forming a stationary phase in order to form a chromatography capillary.

The method of the invention may consist, in step c), in releasably fastening, e.g. by means of an adhesive or touching film, the cover plate on the side walls of the capillaries, in order to enable the array of capillaries to be opened and closed at will.

Advantageously, the method of the invention includes an additional step consisting in preheating the meltable construction material prior to depositing it on the support plate or prior to exposing it to the laser beam, so as to limit the amount of laser energy that is consumed and so as to reduce the risk of the support plate being damaged thermally.

By way of example, a polyethylene powder having a grain size lying in the range 1 μm to 10 μm (e.g. being about 3 μm) presents a melting temperature of about 490° C. and can be preheated to a temperature of 190° C. prior to being deposited on the support plate and melted by laser, the laser being used to raise the temperature of the powder by 300° C., i.e. from 190° C. up to its melting temperature (490° C.).

After the side walls of the capillaries have hardened, the non-melted construction material can be removed from the support plate. When the support plate is completely covered in a layer of construction material, removal of the non-melted construction material from the support plate is necessary in order to cause the capillaries to appear.

Steps a) and b) may be repeated one or more times, where necessary, prior to fastening the cover plate on the side walls of the capillaries.

The method may also comprise, prior to step c), the steps that consist in fixing chemical and/or biological molecules on the support plate and/or on the cover plate, within the capillaries, and then in covering these molecules in a layer of soluble protective material. The description above and the examples covering the step of using a protective material applies identically in the present implementation of the invention.

As described above, the protective material is designed to cover the molecules and to protect them, in particular against the radiation and the heat caused by focusing the laser beam on the capillaries for bonding the cover plate onto the walls of the capillaries. The protective material may be a gel of polyacrylamide or of agarose. It may also be a sugar or an ethylene diamino tetraacetic acid (EDTA) in powder or gel form.

The method may also comprise, before step a), the steps consisting in fixing chemical or biological molecules on the support plate in the bottoms of the future capillaries, and then in covering these molecules in a layer of a soluble protective material.

Unlike certain other implementations described above, when the molecules are fixed on the support plate prior to forming the walls of the capillaries, they need to be protected in order to avoid being degraded, in particular during the steps of depositing and melting the construction material on the support plate.

For this purpose, the molecules may be covered in a layer of soluble protective material. This protective material may be deposited by means of a mold or a mask of predetermined shape giving access to the molecules that have previously been positioned on the support plate. The mask or the mold is made of a suitable material, and for example out of any plastics material such as a polyimide (Kapton®, etc.).

When using a mask, it is positioned on the support plate and includes slots or gaps in zones corresponding to the locations of the support plate where a layer of protective material is to be deposited, i.e. the locations of the plate where the molecules are fixed. A layer of protective material is then deposited on said mask and a portion of said layer passes through the gaps or slots of the mask and covers the molecules fixed on the support plate. The mask may subsequently be withdrawn.

The mask may also be placed on and permanently fastened to the support plate, with step a) then consisting in depositing at least one layer of construction material on the mask. The mask may be formed by a plate of Kapton® that is covered on at least one of its faces in a layer of an EVA copolymer for adhesively fastening it to the support plate by using a laser, as described above. The gaps or slots in the mask may previously be formed by laser cutting and they may form an array of capillaries that is independent and that is designed to be connected in fluid flow manner to the array of capillaries formed by melting or polymerizing the construction material deposited on the mask, as described in greater detail below.

When using a mold, it has a plane surface for putting into contact with the surface of the support plate on which molecules are fixed, and including grooves or recesses in zones that correspond to the locations of the support plate where a layer of protective material is to be deposited. The grooves or the recesses in the mold are filled with protective material and then the surface of the mold presenting these recesses is put into contact with the surface of the support plate on which the molecules are fixed, in order to cover the molecules in a layer of protective material. The mold can then be removed from the support plate.

The method of the invention may also include a step consisting in removing, by laser ablation or by any other suitable technique, the surplus protective material that is not covering chemical or biological molecules.

The surplus protective material should be understood as being the quantity of material that does not cover chemical or biological molecules and that is therefore not necessary, or that is in danger of hindering or preventing the side walls of the capillaries being formed.

The wavelength of the laser beam is determined so as to ablate the protective material without any risk of degrading the support plate, or any electrodes on the plate.

This step may follow the above-mentioned step of depositing a layer of protective material using a suitable mold or mask, or some other step of depositing a layer of protective material, e.g. with the help of a robotic system.

When the protective material is meltable, the method of the invention may also include a step that consists in focusing and moving a laser beam on and over all or part of the layer of protective material in order to melt it. The melting of the protective material followed by its hardening by cooling serves to protect the molecules fixed on the support plate in stable and effective manner.

The surplus melted material may optionally be removed by laser ablation, as described above.

When the diffractive index and the color of the meltable protective material are close to those of the support plate, the protective material may be mixed with a dye so as to offset its light absorption towards a predetermined wavelength, thereby avoiding the support plate absorbing a fraction of the light emitted by the laser.

Under such circumstances, the protective material is preferably in the form of a powder or gel and is constituted, for example, by a sugar or by EDTA, which are very hydrophilic and compatible with the biological or chemical material. The size of the grains of the powder of protective material need not necessarily be uniform and may for example lie in the range about 1 μm to 10 μm.

In a variant, the protective material is polymerizable and a laser beam is focused and moved on and over all or part of the layer of protective material in order to cause it to polymerize.

The protective material may also be caused to polymerize by applying an electric field by means of electrodes present on the support plate. The protective material may then be based on pyrrole.

In yet another variant, the method consists in dissolving the protective material in a suitable solvent which is then deposited on the support plate over the molecules. An additional step of natural or forced evaporation of the solvent ensures that the protective material dries and hardens.

The advantage of a protective material that is hardened by cooling, by polymerization, or by evaporation, is that it can be used as a mold for depositing the construction material used in step a).

The method of the invention may consist, in step c), in:

c₁) depositing another layer of meltable construction material on the walls of the capillaries, after they have hardened;

c₂) placing the cover plate on said layer; and

c₃) focusing and moving a laser beam in register with the side walls of the capillaries to cause the layer to melt at said walls so as to fasten the cover plate adhesively on the side walls of the capillaries.

The thickness of the layer of construction material deposited on the walls of the capillaries lies for example in the range about 1 μm to about 2 μm.

Once the cover plate has been fastened on the walls of the capillaries, the protective material can be conserved in the capillaries, as described above, and/or it can be removed from the capillaries by dissolving the layer of protective material in a suitable solvent, e.g. water, injected into the capillaries through channels or pores formed in the support plate and/or the cover plate, and evacuated from the capillaries via said channels or said pores.

The cover plate may optionally be fastened in removable manner on the side walls of the capillaries, as described above.

The present invention also provides a chip including an array of capillaries and characterized in that it comprises a support plate and a cover plate that are substantially mutually parallel with the side walls of the capillaries extending between them, the side walls being formed by using a laser to melt or polymerize a construction material, the cover plate being fastened on the side walls of the capillaries via an adhesion layer.

This adhesion layer may be formed by an adhesive or touching film, or by melting or using a laser to melt or polymerize a material in film or powder form. Advantageously, the cover plate is releasably fastened on the side walls of the capillaries.

The support and cover plates of the chip are preferably made of materials that are compatible with the biological or chemical material and comprising, for example, a slide of glass, of quartz, of plastics material, or of any other suitable material.

The material of the cover plate may also be selected so as to be transparent at least one wavelength of the laser beam that is used for causing the material that is to form the adhesion layer to melt or to polymerize.

The plate may include electrodes, e.g. etched or deposited as a thin film on the slide, and separated from one another by dielectric elements, e.g. made of silica (SiO₂). The etching of electrodes on a slide consists, for example, in depositing a metal foil on the slide and in performing etching of the lithographic, photolithographic, or laser ablation type on said foil.

The electrodes of the chip enable an electric field to be applied in the array of capillaries so as to cause charged molecules to migrate by electrophoresis from one point of the array to another. They may also be used for confining molecules in a region of the array of capillaries, for measuring variations in impedance, etc.

By way of example, the electrodes may be made of an alloy of tin oxide or of zinc, such as: indium tin oxide (ITO); antimony tin oxide (ATO); fluorine tin oxide (FTO); or zinc oxide (ZnO).

Each of the plates from the support and cover plates may be covered in a film of electrically insulating material for electrically insulating the electrodes from the capillary walls which may themselves be metallic.

By way of example, in the context of analyzing a mixture of molecular targets, at least one of the plates may be covered in a film that facilitates the fixing by mechanical deposition or by in situ polymerization of chemical or biological molecules, such as molecular probes for hybridizing with molecular targets and forming probe-target complexes when the mixture is brought into contact with the probes. The film may also cover the above-mentioned electrodes so as to eliminate any risk of a redox reaction at the electrodes.

The chemical or biological molecules may be fixed in at least one of the capillaries, on the support plate and/or on the cover plate.

By way of example, the or each of the plates of the chip may be covered in a film of polyimide facilitating fixing biological or chemical molecules.

At least one of the plates may include a plurality of chemical or biological molecules organized as spots and regularly spaced apart from one another so as to form a matrix of spots.

Typically, the capillaries of the chip present a height and a width lying in the range about 1 μm to about 2000 μm. In a particular example, the capillaries present a square section with a height and a width of about 100 μm.

The array of capillaries of the chip may be connected to at least one reservoir having side walls that extend between the support plate and the cover plate of the chip. The side walls of the or each reservoir may be formed by the method of the invention.

In an embodiment, the capillaries extend substantially parallel to one another and they are connected at each of their ends to a reservoir. By way of example, the reservoirs may be connected to means for injecting and removing a mixture of target molecules into and from the array of capillaries.

By way of example, the array of capillaries of the chip may comprise at least one chromatography capillary filled with a porous monolithic substance forming a stationary phase, and at least one electrophoresis capillary connected substantially perpendicularly to the chromatography capillary.

The array of capillaries of the chip is preferably connected to at least one chamber for analysis by the laser induced breakdown spectroscopy (LIBS) effect having its side walls extending between the support plate and the cover plate of the chip. The side walls of the or each analysis chamber may be formed by the method of the invention.

Analysis by the LIBS effect is an analysis technique by light emission spectroscopy from a plasma produced by the laser, and it consists in focusing a laser beam, e.g. a pulsed type beam, onto a surface of a sample for analysis so as to produce a plasma constituted by particular elements of the sample. The plasma emits light radiation and analyzing the atomic and ionic spectrum lines in said radiation serves to discover the respective concentrations of various elements making up the sample.

Finally, the present invention provides a device for analysis by the LIBS effect, which device comprises a chip as described above, means for emitting a laser beam onto a surface of the sample contained in an analysis chamber of the chip, through a transparent wall thereof, to cause a plasma to be formed and expand in the chamber, and means for spectrometric detection and analysis of the light emitted by the plasma through the transparent wall of the chamber, said transparent wall being a quartz lens, for example.

The device of the invention preferably includes means for injecting a gas into the chamber, the gas advantageously being argon or nitrogen, thus also making it possible to increase the light emission signal from the plasma.

The invention can be better understood and other details, characteristics, and advantages of the present invention appear more clearly on reading the following description made by way of non-limiting example and with reference to the accompanying drawings, in which:

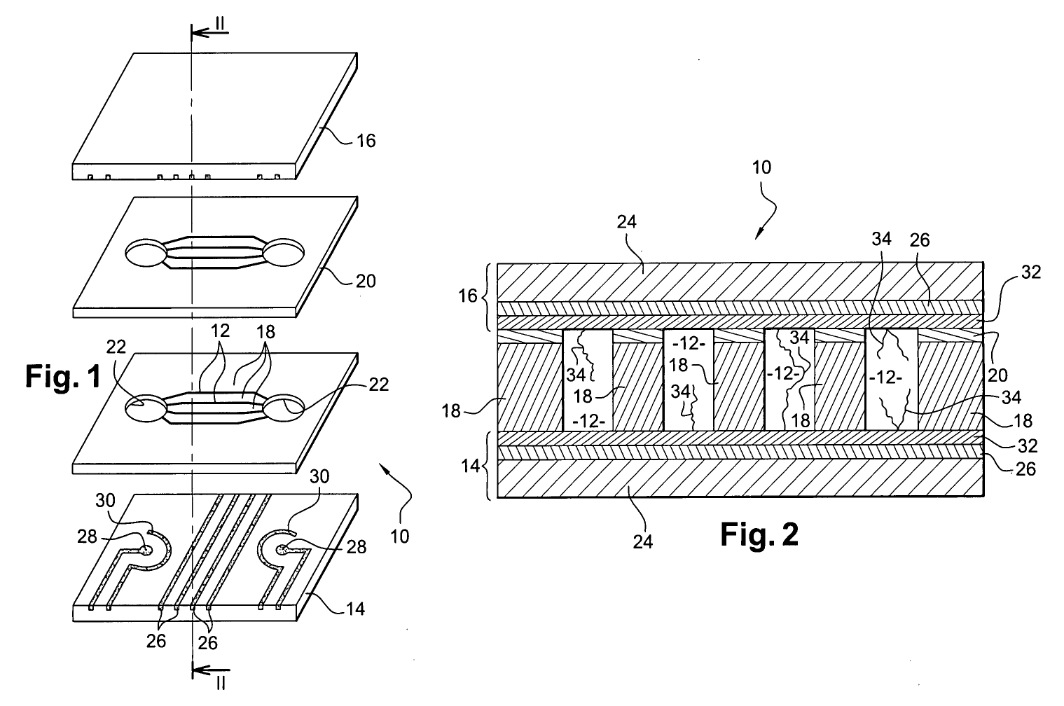

FIG. 1 is a diagrammatic exploded perspective view of the chip of the invention;

FIG. 2 is a section view on line II-II of FIG. 1;

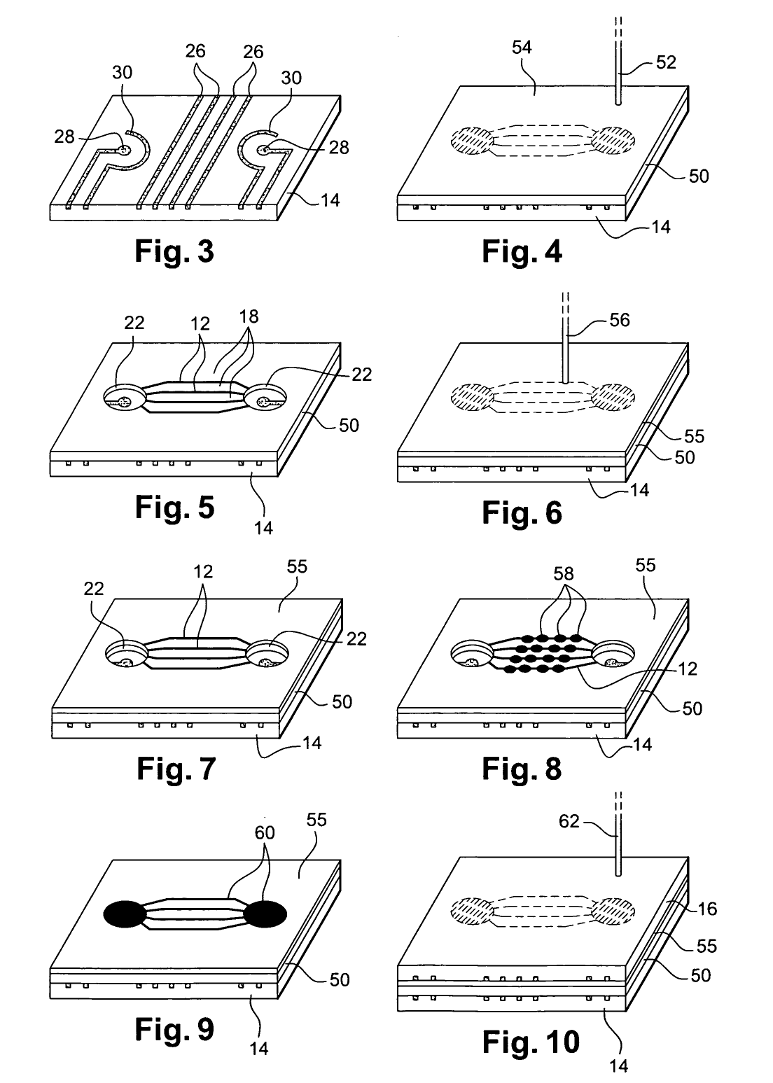

FIGS. 3 to 10 are diagrammatic perspective views showing steps in an implementation of the method of the invention for fabricating an array of capillaries in a chip;

FIGS. 11 to 17 are diagrammatic perspective views showing steps in a variant implementation of the method of the invention;

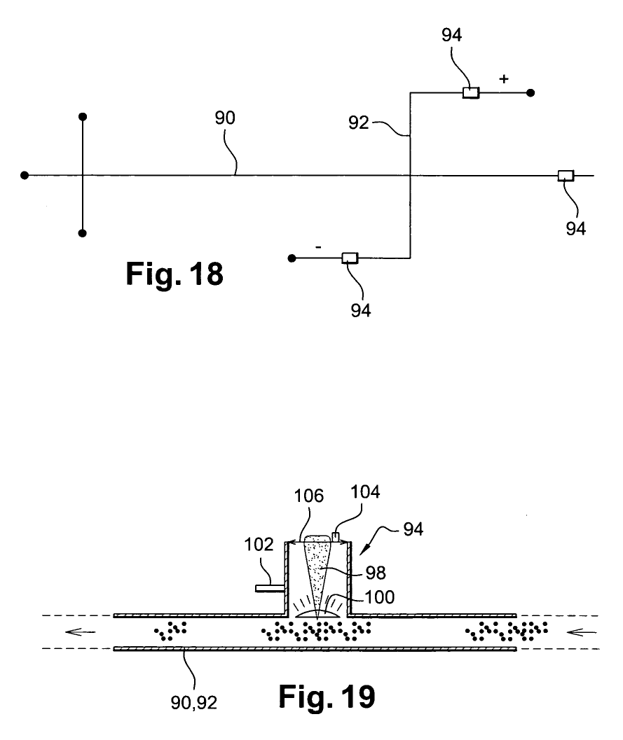

FIG. 18 is a highly diagrammatic representation of an embodiment of an array of chromatography and electrophoresis capillaries of a chip; and

FIG. 19 is a view on a larger scale showing a portion of FIG. 18.

The chip 10 of the invention as shown diagrammatically in FIGS. 1 and 2 is in the form of a rectangular parallelepiped and includes an array of capillaries 12 formed between a bottom plate 14 referred to as a “support”, and a top plate 16 referred to as a “cover” and respectively constituting the bottoms and the ceilings of the capillaries 2. The plates 14 and 16 extend substantially parallel to each other.

The capillaries 12 are separated from one another and from the edges of the chip 10 by walls 18 that extend substantially perpendicularly to the plates 14 and 16 and that are formed directly on the support plate 14 by laser-induced polymerization or melting of at least one layer of construction material deposited on the plate 14, as described below in greater detail.

Forming the side walls 18 of the capillaries by melting or by polymerizing the construction material directly on the support plate 14 enables the walls 18 of the capillaries to be held on the plate 14 merely by adhesion or anchoring, once they have hardened.

The cover plate 16 is fastened on the walls 18 of the capillaries by means of an adhesion layer 20 that is formed by an adhesive or contacting film or from a material in powder or film form that is melted or polymerized by laser so as to cause the cover plate 16 to adhere to the walls 18 of the capillaries.

In the example shown, the capillaries 12 are four in number and they extend substantially parallel to one another between two cylindrical reservoirs 22 formed between the plates 14 and 16, the plate 14 forming the bottoms of the reservoirs and the plate 16 forming the ceilings of the reservoirs. The side walls 18 of the reservoirs 22 are formed in the same manner and at the same time as the side walls 18 of the capillaries 12, in the manner described in greater detail below.

By way of example, the reservoirs 22 are connected to means for feeding or injecting a mixture of molecular targets into the capillary array and to detector means, e.g. using mass spectrometry.

The support and cover plates 14 and 16 are made of materials that are compatible with chemical or biological material and each comprises a slide 24 of dielectric material such as glass, quartz, silica, a plastic material, etc. on its surface that comes into (direct or indirect) contact with the capillaries having electrodes 26, 28, 30 etched or deposited as a thin film thereon by an appropriate technique.

By way of example, these electrodes 26, 28, 30 may be used for applying an electric field to the capillaries 12 in the array so as to cause charge molecules to migrate by electrophoresis from one point to another of the array, so as to confine molecules in a region of the capillary array, so as to measure variations in impedance, etc.

By way of example, these electrodes are made of gold or of an alloy of tin or zinc oxide, such as: ITO; ATO; FTO; or ZnO; and they are separated from one another by dielectric elements (not shown) e.g. made of silica.

In the example shown, each plate 14, 16 has four parallel rectilinear electrodes 26 etched or deposited on a middle portion of the plate 14, 16, these electrodes 26 being designed to extend substantially perpendicularly to the capillaries 12 of the chip.

Each plate 14, 16 also has two pairs of electrodes 28, 30 etched or deposited on end portions of the plate 14, 16, each of these electrode pairs comprising a circular electrode 28 that is to be situated substantially at the center of the bottom or the ceiling of a reservoir 22, and a curved electrode 30 situated between the circular electrode 28 and the rectilinear electrode 26 and designed to extend around a portion of the reservoir.

The electrodes 26, 28, 30 are connected at an edge of the plate 14 or 16 to appropriate means such as means for generating an electric current, means for measuring impedance, etc.

Each plate 14, 16 also comprises a film 32 for facilitating in situ fixing by mechanical deposition or by polymerization of chemical or biological molecules 34 in the capillaries of the plate, the film covering the electrodes 26, 28, 30 and being designed to form the bottoms or the ceilings of the capillaries 12 and the reservoirs 22.

The molecules 34 may be fixed in the capillaries on one or other of the plates 14, 16, or on both of them. Depending on circumstances, chemical or biological molecules can be fixed in the capillaries, in register with the electrodes 26 or between them.

The plates 14, 16 typically have a thickness of approximately 1000 μm and the walls of the capillaries 12 and of the reservoirs 22 have a thickness lying in the range about 1 μm to about 2000 μm, and are for example about 100 μm thick. The capillaries are square or rectangular in section.

FIGS. 3 to 10 show the steps of a first implementation of the method of the invention for fabricating a capillary array of a chip, the method consisting in particular in forming the side walls of the capillaries 12 and of the reservoirs 22 of the chip by polymerizing at least one layer of a construction material that is in the form of a gel or film deposited on a support plate 14.

In the first step of the method as shown in FIG. 4, a photo-imageable film 50 of the Vacrel® or Riston® type and having a thickness of about 75 μm to 150 μm is deposited on one surface of the support plate 14 by a suitable technique, e.g. manually or by using a robotic system, so that the film covers the entire surface.

The second step of the method of the invention consists in focusing and moving a laser beam 52 on and over predetermined zones 54 of the film 50 in order to cause the film to polymerize in these zones so as to form the side walls of the capillaries 12 and of the reservoirs 22.

The laser beam 52 is emitted by a laser generator (not shown) at a wavelength of about 532 nm in the visible range, and by way of example it is a beam of the pulsed type having a repetition frequency of about 10 kilohertz (kHz) to about 50 kHz and a power of about 1 watt (W) to about 10 W. The dimension of the point of impact of the laser beam on the film 50 is typically of the order of 20 μm to 30 μm in diameter.

The laser beam 52 is moved over the zones 54 of the film 50 by means of galvanometrically or piezoelectrically controlled mirrors, these zones being represented diagrammatically in FIG. 4 by the portions of the film that are situated away from dashed lines and shaded regions.

After the walls 18 of the capillaries and of the reservoirs have hardened, the method consists, in a third step, in immersing the support plate in a bath containing soda at a concentration of 0.1 moles per liter (mol.L⁻¹) so as to dissolve the material of the non-polymerized film 50 and so as to cause the capillaries 12 and the reservoirs 22 to appear (FIG. 5). The capillaries and the reservoirs are formed at those locations of the film 50 that were not exposed to the laser beam 52, i.e. at locations that correspond to the dashed lines and to the shaded regions in FIG. 4.

In another step of the method of the invention, the walls 18 are covered in an adhesion layer 55 having a low melting temperature that is formed by a film of paraffin or a film of ethylene and vinyl acetate (EVA) copolymer having thickness lying in the range about 1 μm to 2 μm (FIG. 6).

A laser beam 56 is focused and moved over the EVA film along the capillaries 12 and over the reservoirs 22 in order to eliminate the EVA film from the ceilings of the capillaries and the reservoirs, i.e. in register with the dashed lines and the shaded regions of FIG. 6.

The laser beam 56 is emitted by a pulsed emission laser generator at a wavelength of 532 nm (green) with a repetition frequency of about 10 kHz and a power of about 1 W so as to cause the EVA film to melt. The laser beam is focused in the middle of the capillaries and is moved along the capillaries so as to cause the film to melt and the melted film to retract along the outer longitudinal edges of the capillaries 12 (FIG. 7). The melting temperature of the EVA film is about 176° C.

The laser beam 56 can also be emitted at a wavelength of 1064 nm in order to give rise to ablation of the paraffin film or of the EVA film, i.e. to order to sublime the film.

In the following step shown in FIG. 8, chemical or biological molecules 58 organized as spots are fixed in the capillaries on the support plate, over the electrodes 26. Each capillary of the array has a line of four regularly spaced-apart spots, the spots of each capillary being in alignment with the spots of the other capillaries so as to form a matrix of four rows of four spots.

The molecules are subsequently covered in a gel 60 of polyacrylamide, of agarose, or of EDTA (FIG. 9) in order to protect them during the last step of the method, which step consists in placing the cover plate 16 on the paraffin film 55 and then in focusing and moving a laser beam 62 in register with the walls 18 of the capillaries and of the reservoirs, through the cover plate 16 so as to melt the film on said walls, thereby bonding the cover plate adhesively to the walls 18 (FIG. 10).

The laser beam 62 is also emitted by a laser generator at a wavelength of 532 nm (green) and is focused and moved in register with the walls 18 of the capillaries and of the reservoirs, i.e. away from the dashed lines and the shaded regions of FIG. 10.

The polyacrylamide or agarose gel is advantageously conserved in the capillaries 12 and in the reservoirs 22 to form a diffusion medium for other molecules such as the molecular targets when they migrate merely by diffusion or by applying an electric field when using electrophoresis.

The gel, e.g. EDTA, may also be removed from the capillary array by causing a solvent such as water to flow in the capillaries, the solvent serving to dissolve the gel and then be removed from the capillaries. The solvent can be injected and evacuated to and from the capillaries via channels (not shown) formed in at least one of the plates 14, 16, each of these channels opening out at one end into the capillaries or the reservoirs and being connected at its other end to appropriate means for injecting and evacuating solvent.

FIGS. 11 to 17 show the steps of a second implementation of the method of the invention, this method consisting, amongst other things, in forming the side walls of the capillaries 12 and of the reservoirs 22 of a chip by melting at least one layer of a construction material in powder form on a support plate 14.

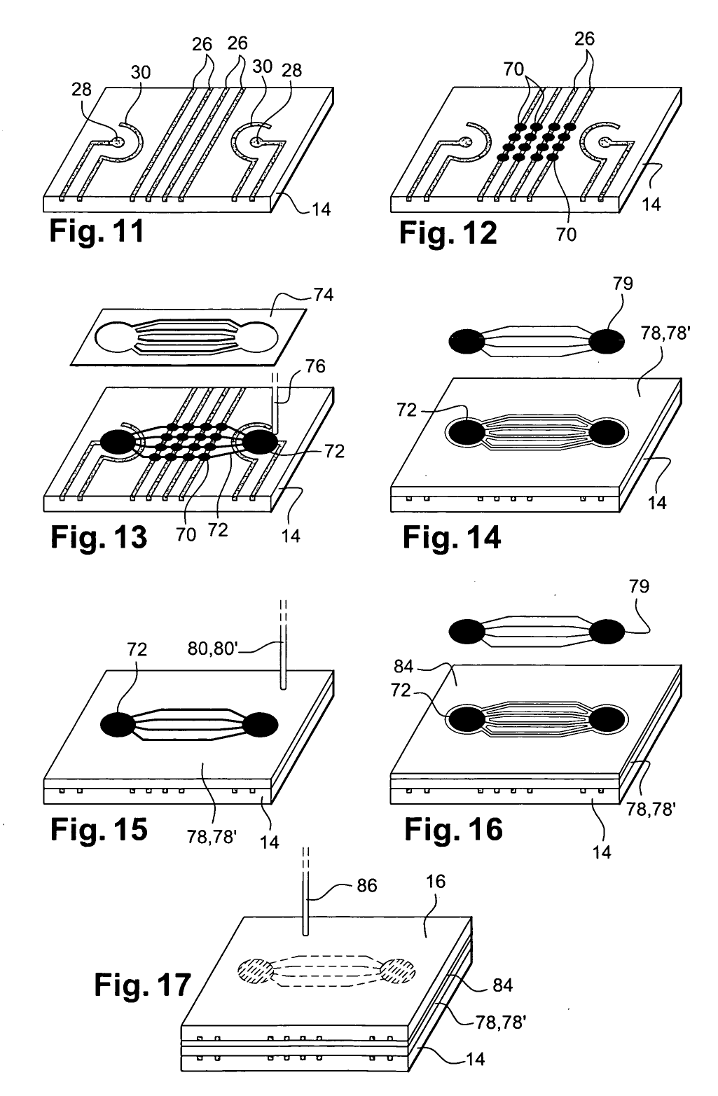

In the first step of the method shown in FIG. 12, chemical or biological molecules 70 organized as spots are fixed on a surface of the support plate 14 in register with electrodes 26 and with the locations of the future capillaries 12.

These molecules are covered in a layer 72 of EDTA powder (FIG. 13) in order to protect them while the walls of the capillaries and of the reservoirs are being formed.

The EDTA may previously be dissolved in water so as to form a gel that is deposited on the molecules on the bottoms of the future capillaries by an appropriate technique. The support plate is then placed in an oven to evaporate the water and dry and harden the EDTA. The water can also be allowed to evaporate naturally.

In a variant, and as shown, the EDTA powder is deposited on a surface of the plate 14 in register with the bottoms of the future capillaries and the future reservoirs by means of a mask 74 of appropriate shape that is previously positioned on said surface.

The following step of the method consists in focusing a layer beam 76 on and moving it over the layer 72 in order to melt the EDTA so as to form a layer that is relatively rigid and compact, once it has hardened (FIG. 13). The laser beam 76 is emitted by a laser generator at a wavelength of about 532 nm or about 1064 nm with a power of about 5 W.

A layer 78 of polymethylmethacrylate (PMMA) powder or of chlorinated polyvinylchloride (CPVC) having a thickness of about 100 μm to 200 μm is then deposited on the portions of the surface of the plate 14 that are not covered in melted EDTA. This step can be performed with the help of a mask 79 of appropriate shape previously positioned on the layer of melted EDTA (FIG. 14).

A laser beam 80 is then focused and moved on and moved over the entire layer 78 in order to melt the PMMA or CPVC powder so as to form the side walls 18 of the capillaries 12 and of the reservoirs 22 (FIG. 15). The laser beam 80 is emitted by a laser generator at a wavelength of about 1064 nm (infrared (IR)) at a power lying in the range about 20 W to about 200 W.

Thereafter, method consists in repeating the steps of FIGS. 14 and 15, i.e. in depositing an additional layer 78′ of PMMA or CPVC powder on the layer 78 to a thickness of about 100 μm to 200 μm after hardening, and once more focusing a laser beam 80′ on and moving it over all of said additional layer 78′ in order to cause it to melt so as to finish off forming the walls 18.

In another step of the method of the invention, the walls 18 are covered by an adhesion layer 84 having a low melting temperature that is constituted in this example by another layer of PMMA or CPVC powder having a thickness of about 1 μm to 3 μm. This step can likewise be performed with the help of the above-mentioned mask 79 (FIG. 16).

The last step of the method consists in placing the cover plate 16 on said layer 84 and then in focusing and moving a laser beam 86 in register with the walls 18 of the capillaries and the reservoirs through the cover plate 16 so as to cause the PMMA or CPVC powder to melt on said walls and thereby fasten the plate 16 on the walls 18 by adhesion (FIG. 17).

The laser beam 86 is also emitted by a laser generator at a wavelength of 1064 nm (UV) and it is moved over regions situated away from the dashed lines and the shaded regions of FIG. 17.

The melted EDTA is removed from the capillary array by causing a solvent such as water to flow through the capillaries. As described, the solvent can be injected into the capillaries via pores formed in at least one of the plates 14, 16 and opening out into at least one of the reservoirs.

In a variant implementation (not shown), the method of the invention consists in forming the walls 18 of the capillaries 12 and of the reservoirs 22 by melting at least one layer of a construction material in powder form on a support plate 14 prior to fixing chemical or biological molecules on the plate.

In a first step of this method, a layer of PMMA or CPVC powder having a thickness of about 300 μm is deposited over the entire surface of the plate 14 (as shown in FIG. 4) and then a laser beam is focused on and moved over the above-mentioned regions of the layer.

The powder that has not melted is subsequently removed from the plate 14, e.g. by causing a liquid such as a water to flow over the support plate or by sweeping by blowing a gas under pressure, such as air, over the support plate.

In the following step, and as shown in FIG. 8, chemical or biological molecules organized as spots are fixed in the capillaries on the support plate.

These molecules are then covered in a layer of EDTA gel so as to protect them during the last step of the method, which step consists in fastening the cover plate 16 on the walls of the capillaries and of the reservoirs.

The plate 16 is then placed on the film and a laser beam is focused and moved in register with the walls of the capillaries and the reservoirs, through the plate 16, in order to cause the EVA film to melt on said walls so as to fasten the cover plate adhesively on the walls 18.

For this purpose, the laser beam is emitted by a laser generator at a wavelength of about 532 nm or about 1064 nm at a power lying in the range about 1 W to about 50 W.

In the last step of the method, the EDTA gel is removed by causing a solvent to flow in the array of capillaries, as described above.

In another variant implementation of the method of the invention, the above-mentioned mask 74 that is used to deposit the EDTA powder on the molecules 70 is fastened permanently on the support plate 14, and the slots or gaps in said mask through which the EDTA powder is deposited form a second array of capillaries and/or reservoirs for being put into fluid communication with the array of capillaries made by melting or polymerizing the construction material using a laser.

The mask may be formed by a sandwich structure comprising a Kapton® plate interleaved between two films of an EVA or a polydimethyl siloxane (PDMS) copolymer, with the total thickness of this structure lying for example in the range about 10 μm to about 2000 μm, and with the thickness of each EVA or PDMS film being for example about 1 μm to 2 μm.

The capillaries and/or the reservoirs of the second array are formed in the structure by laser coupling (i.e. by ablation of the materials of the structure), which array may be formed over all or only a fraction of the thickness of the structure. By way of example, and when the second array is of a shape similar to that of the array formed by laser melting or polymerization of a construction material, the reservoirs 22 and the middle portions of the capillaries 12 are formed through the entire thickness of the structure, while the ends of the capillaries that connect them to the reservoirs are formed over a depth of the structure representing about 95% of the thickness of the Kapton® plate, such that the side walls of the capillaries that extend between two adjacent capillaries are connected to the remainder of the structure by the remaining thickness (about 5%) of the Kapton® plate.

The capillaries and the reservoirs may optionally be formed by laser cutting a Kapton® plate that is subsequently covered by an EVA or PDMS film on each of its faces.

In the following step, the structure is placed on the support plate in such a manner that the small thickness (5%) of the Kapton® plate is situated beside the support plate. The structure is then fastened to the support plate by focusing a laser beam on the EVA film and moving it thereover through the support plate in order to melt the film. When the Kapton® plate is covered in a film of PDMS, the Kapton® plate is pressed against the support plate in order to fasten them together.

Where necessary, the method then consists in using laser ablation to pierce at least one orifice in the EVA or PDMS film situated on the side remote from the support plate in order to form a fluid flow communication path between the second array and the capillary array (e.g. in the reservoirs) that is formed by depositing and melting or polymerizing a layer of construction material that is deposited on said film.

In a variant, the capillary array formed by the mask is of a shape that is different from that of the array formed by laser melting or polymerization.

In the above examples, the cover plate may also be releasably fastened on the side walls of the capillaries by means of an adhesive or joining film, e.g. a film of PDMS that is inserted between the cover plate and the side walls of the array. Pressure is applied to the cover plate and serves to compress the film between the plate and the side walls so as to fix one against the other merely by mechanical adhesion or anchoring of the film in the roughnesses of the side walls and of the cover plate.

FIG. 18 is a highly diagrammatic representation of one possible array of capillaries in a chip, this capillary array comprising a chromatography capillary 90, an electrophoresis capillary 92, and chambers 94 for spectrometric analysis by laser induced breakdown spectroscopy (LIBS), the side walls of the capillaries and of the chambers being formed between support and cover plates by the method of the invention.

The chromatography capillary 90 is filled with a porous monolithic substance forming a stationary phase and it is connected at one of its ends to means for supplying it with a moving phase and to means for injecting at least one sample, and at its other end to a chamber 94 for performing analysis by the LIBS effect. In known manner, this capillary makes it possible to fraction the components of a sample and to detect and quantify them one after another in the analysis chamber as a function of their elution times.

In the example shown, the electrophoresis capillary 92 is substantially S-shaped and it has a middle portion connected perpendicularly to the chromatography capillary 90, the end portions of the electrophoresis capillary 92 being respectively connected to an anode and to a cathode in order to apply an electric field to the capillary. The electrophoresis capillary 92 is also connected at its ends to chambers 94 for analysis by the LIBS effect.

The eluted fractions of the sample injected into the chromatography capillary 90 are directed towards one or the other of the analysis chambers 94 of the electrophoresis capillary 92 as a function of the presence of positively or negatively charged molecules in these fractions. Fractions containing a majority of negatively charged molecules will be directed towards the analysis chamber 94 in the end portion of the capillary 92 connected to the anode (+), and fractions containing a majority of positively charged molecules will be directed towards the analysis chamber 94 of the end portion of the capillary 92 that is connected to the cathode (−). In the absence of any charged molecules in the fractions, they continue to be eluted along the chromatography capillary 90 and are detected and quantified in the analysis chamber 94 of the capillary.

FIG. 19 is a diagrammatic representation of a chamber 94 for analysis by the LIBS effect, said chamber being mounted at one end on an open segment of the electrophoresis capillary 92 (or of the chromatography capillary 90) and it presents at its opposite end a quartz lens 106 through which a laser beam 98 is focused onto a surface of the medium for causing fractions to migrate along the capillary, through the opening in the capillary. The lens could also be made of a plastics material that is transparent at the wavelength of the laser beam, e.g. that is transparent to ultraviolet (UV) rays.

When a fraction of the sample passes in front of the lens 106 of the chamber and a laser beam 98 is focused through said lens onto the surface of the migration medium, a plasma 100 is created in the chamber, which plasma is constituted by particular elements of said fraction. The plasma emits light radiation that is detected and analyzed by suitable means 104 in order to determine the respective concentrations of the various elements constituting the fraction of the sample. By way of example, for a sample that comprises nucleic acids, the means 104 are designed to determine the concentration of phosphorous in the fractions of the sample.

The analysis chamber is also connected to means 102 for injecting a gas such as argon or nitrogen into the chamber so as to prevent the migration medium from penetrating into the chamber through the opening in the segment of the capillary.

In a variant, the open segment of the capillary 90 or 92 is filled with a porous monolithic substance such as a porous mineral or metal so as to reduce the volume occupied by the migration medium in the segment of the capillary and so as to increase the concentrations of molecules from the fractions in said segments so as to make them easier to detect and to analyze.

The analysis chamber 94 may also have a pair of electrodes connected to an electricity source and disposed suitably in the chamber so as to apply an electric field in the segment of the capillary, preferably perpendicularly to the direction in which fractions migrate in the capillary, so as to bring the charged molecules of these fractions to the surface of the migration medium on which the laser beam is focused. This makes it possible to increase the quantity of molecules that are exposed to the laser beam emitted through the lens, and thus to improve analysis of the sample.

Focusing the laser beam on the surface of the migration medium also makes it possible to accelerate migration of the fractions along the capillary by a thermal pumping effect.

1-49. (canceled)

50. A method of fabricating an array of capillaries of a chip, wherein it comprises the steps consisting in:
a) depositing at least one layer of a meltable or polymerizable construction material on a support plate that is to form the bottoms of the capillaries;
b) focusing and moving a laser beam on and over predetermined zones of the or each layer of construction material in order to cause the material in said zones to respectively melt or to polymerize so as to form the side walls of the capillaries; and
c) fastening a cover plate on the side walls of the capillaries once they have hardened, said cover plate forming the ceilings of the capillaries;
the method further consisting, prior to step a) and/or c), in fixing chemical or biological molecules on the support plate and/or on the cover plate in register with at least one of the capillaries, and in covering said molecules in a layer of a soluble protective material.

51. A method of fabricating an array of capillaries of a chip, wherein it comprises the steps consisting in:
a) depositing at least one layer of a meltable construction material on a support plate that is to form the bottoms of the capillaries;
b) focusing and moving a laser beam on and over predetermined zones of the or each layer of construction material to cause the material to melt in said zones so as to form the side walls of the capillaries; and
c) fastening a cover plate on the side walls of the capillaries after they have hardened, said cover plate forming the ceilings of the capillaries.

52. A method according to claim 50, wherein it further comprises, prior to step c), the step consisting in repeating steps a) and b) one or more times until the side walls of the capillaries reach a predetermined height.

53. A method according to claim 50, wherein it further comprises, prior to step c) or after each step b), the step consisting in removing the construction material that has not melted or has not polymerized.

54. A method according to claim 50, wherein it further comprises, prior to step c), the step consisting in filling at least one of the capillaries with a porous monolithic substance forming a stationary phase so as to constitute a chromatography capillary.

55. A method according to claim 50, wherein it consists, in step c), in releasably fastening the cover plate on the side walls of the capillaries.

56. A method according to claim 50, wherein it consists, in step a), in depositing at least one layer of a polymerizable construction material in the form of a gel or a film on the support plate, and in step b), in focusing and moving a laser beam on and over predetermined zones of the or each layer of construction material in order to cause the material to polymerize in said zones so as to form the side walls of the capillaries.

57. A method according to claim 56, wherein it consists, in step c), in:
c₁) covering the side walls of the capillaries in a film of material having a low melting temperature, after the walls have hardened;
c₅) placing the cover plate on the film of material; and
c₆) focusing and moving a laser beam in register with the side walls of the capillaries to melt the film on the side walls so as to fasten the cover plate adhesively on the side walls of the capillaries.

58. A method according to claim 57, wherein it further comprises, after step c₁), the step consisting in:
c₂) focusing and moving a laser beam along the capillaries to open the capillaries by eliminating the film of material from the ceilings of the capillaries.

59. A method according to claim 57, wherein it further comprises, after step c₁) or step c₂), and before step c₅), the steps consisting in:
c₃) fixing chemical or biological molecules on the support plate in the capillaries; and
c₄) covering these molecules in a layer of soluble protective material.

60. A method according to claim 59, wherein it further comprises, after step c₆), the step consisting in:
c₇) removing the layer of protective material by dissolving said material in a suitable solvent injected into the capillaries via channels formed in the support plate and/or the cover plate, and by evacuating the solvent via said channels.

61. A method according to claim 57, wherein the film of material is a film of paraffin or a film of EVA copolymer.

62. A method according to claim 50, wherein it consists, in step a), in depositing at least one layer of a meltable construction material in powder form on the support plate, and in step c), in focusing and moving a laser beam on and over predetermined zones of the or each layer of construction material to cause the material to melt in said zones so as to form the side walls of the capillaries.

63. A method according to claim 62, wherein it further comprises, prior to step a) or prior to step b), the step consisting in preheating the meltable construction material.

64. A method according to claim 62, wherein it further comprises, prior to step c), the steps consisting in fixing chemical or biological molecules on the support plate and/or the cover plate in the capillaries, and then in covering said molecules in a layer of soluble protective material.

65. A method according to claim 50, wherein the protective material is a polyacrylamide or agarose gel.

66. A method according to claim 62, wherein it further comprises, prior to step a), the steps consisting in fixing chemical or biological molecules on the support plate in register with the bottoms of future capillaries, and then in covering said molecules in a layer of a soluble protective material.

67. A method according to claim 66, wherein the molecules are covered by the layer of soluble protective material by means of a mold or a mask of predetermined shape previously positioned on the support plate.

68. A method according to claim 66, wherein it further comprises the step consisting in using laser ablation to remove the surplus protective material that does not cover chemical or biological molecules.

69. A method according to claim 66, wherein, when the protective material is meltable, the method further comprises the step consisting in focusing and moving a laser beam on and over all or part of the layer of protective material in order to melt it.

70. A method according to claim 69, wherein the protective material is mixed with a dye so as to offset its light absorption towards a predetermined wavelength.

71. A method according to claim 50, wherein the protective material is in powder or gel form.

72. A method according to claim 62, wherein it consists, in step c), in:
c₁) depositing another layer of meltable construction material on the walls of the capillaries after they have hardened;
c₂) placing the cover plate on said layer; and
c₃) focusing and moving a laser beam in register with the side walls of the capillaries in order to melt the layer on said walls so as to fasten the cover plate adhesively on the side walls of the capillaries.

73. A method according to claim 72, wherein it further comprises, after step c₃), the step consisting in:
c₄) removing the layer of protective material by dissolving said material using a solvent injected into the capillaries via channels formed in the support plate and/or the cover plate, and by evacuating the solvent via said channels.

74. A method according to claim 62, wherein the grain size of the construction material powder lies in the range about 0.1 μm to about 20 μm.

75. A method according to claim 62, wherein the meltable construction material is organic, metallic, a plastics material, or a ceramic.

76. A method according to claim 50, wherein the or each layer of construction material has a thickness lying in the range about 1 μm to about 2000 μm.

77. A method according to claim 50, wherein the size of the point of impact of the laser beam used for forming the side walls of the capillaries presents a diameter less than about 50 μm.

78. A method according to claim 50, wherein the laser used for forming the side walls of the capillaries is of the pulsed type.

79. A method according to claim 50, wherein the chemical or biological molecules are selected from optionally marked nucleic acids, polypeptide compounds, chemical or biological ligands, and antibodies or antibody fragments.

80. A chip including an array of capillaries, wherein it comprises a support plate and a cover plate that are substantially mutually parallel with the side walls of the capillaries extending between them, the side walls being formed by using a laser to melt or polymerize a construction material, the cover plate being fastened on the side walls of the capillaries via an adhesion layer, and chemical or biological molecules being fixed in at least one of the capillaries on the support plate and/or on the cover plate.

81. A chip including an array of capillaries, wherein it comprises a support plate and a cover plate that are substantially mutually parallel and having the side walls of the capillaries extending therebetween, the side walls being formed by using a laser to melt a construction material, the cover plate being fastened on the side walls of these capillaries via an adhesion layer.

82. A chip according to claim 80, wherein the adhesion layer is formed by an adhesive film.

83. A chip according to claim 80, wherein the adhesion layer is formed by using a layer to melt or polymerize a material in powder or film form.

84. A chip according to claim 80, wherein at least one plate from amongst the support plate and the cover plate comprises a slide made of glass, quartz, or plastics material.

85. A chip according to claim 84, wherein at least one plate from amongst the support plate and the cover plate includes electrodes etched or deposited as a thin layer on the slide and separated from one another by dielectric elements.

86. A chip according to claim 84, wherein at least one plate from amongst the support plate and the cover plate is covered in a film of electrically insulating material for insulating the electrodes of the slide electrically from the side walls of the capillaries.

87. A chip according to claim 80, wherein it includes a plurality of chemical or biological molecules fixed on the support plate and/or the cover plate, said molecules being organized as spots and being regularly distributed relative to one another so as to form a matrix.

88. A chip according to claim 87, wherein at least one plate from the support plate and the cover plate is covered in a film for facilitating fixing by in situ polymerization or by mechanical deposition of the chemical or biological molecules on the plate.

89. A chip according to claim 80, wherein the capillaries present a height and/or a width lying in the range about 1 μm to about 2000 μm.

90. A chip according to claim 80, wherein the array of capillaries is connected to at least one reservoir, the side walls of the or each reservoir extending between the support plate and the cover plate.

91. A chip according to claim 80, wherein the array of capillaries comprises at least one chromatography capillary filled with a porous monolithic substance forming a stationary phase.

92. A chip according to claim 91, wherein the array of capillaries includes at least one electrophoresis capillary connected substantially perpendicularly to the chromatography capillary.

93. A chip according to claim 92, wherein the array of capillaries is connected to at least one chamber for analysis by the LIBS effect, the side walls of the or each chamber extending between the support plate and the cover plate.

94. A device for analysis by the LIBS effect, wherein it comprises at least one chip according to claim 92, means for emitting a laser beam onto a surface of the sample contained in an analysis chamber of the chip, through a transparent wall thereof, to cause a plasma to be formed and expand in the chamber, and means for spectrometric detection and analysis of the light emitted by the plasma through the transparent wall of the chamber.

95. A device according to claim 94, wherein it includes means for injecting a gas such as argon into the analysis chamber of the chip.

96. A device according to claim 94, wherein the transparent wall of the analysis chamber of the chip is a quartz lens.

97. A device according to claim 94, wherein the transparent wall of the analysis chamber of the chip is a lens made of a plastics material that is transparent to UV rays.

98. A device according to claim 94, wherein the analysis chamber includes a pair of electrodes for applying an electric field in the chamber.
